(19) United States
(12) Patent Application Publication
(10) Pub. No.: US 2025/0303758 A1
(43) Pub. Date: Oct. 2, 2025

(54) IMAGE FORMING APPARATUS

(71) Applicant: CANON KABUSHIKI KAISHA, Tokyo (JP)

(72) Inventors: AKIHIRO FUJIWARA, Chiba (JP); MAKOTO MATSUO, Ibaraki (JP); YURI SHIMAMOTO, Chiba (JP); JUN KAWAKITA, Chiba (JP); HIROKI KAJITA, Saitama (JP); SHIMON KADOYA, Chiba (JP); YUSHI SADAMITSU, Tokyo (JP)

(21) Appl. No.: 19/076,334

(22) Filed: Mar. 11, 2025

(30) Foreign Application Priority Data
Mar. 27, 2024 (JP) 2024-051921

(51) Int. Cl. B41J 13/02; B41J 11/00; B41J 13/076; B41J 13/08

(52) U.S. Cl. CPC B41J 13/025; B41J 11/0024; B41J 13/076; B41J 13/08

(57) ABSTRACT

An image forming apparatus includes an image forming unit and a sheet conveyance unit including an endless belt, a plurality of stretch rollers, a tension roller, a heater, a first urging member, a first switching unit, a second urging member, a second switching unit, and an operation portion. The first switching unit switch the tension roller between a first state in which the tension roller does not urge the belt by not being urged with the first urging member, and a second state in which the tension roller urges the belt by a first urging force by being urged with the first urging member. The second switching unit switch the tension roller between the second state and a third state in which the tension roller urges the belt by a second urging force that is larger than the first urging force by being urged with the second urging member.

### BACKGROUND OF THE INVENTION

### Field of the Invention

This disclosure relates to an image forming apparatus that forms an image on a sheet.

### Description of the Related Art

In image forming apparatuses, as a configuration to convey a sheet, heating belts are widely used as a configuration to dry the sheet, serving as a recording medium. For example, in inkjet recording apparatuses that form an image on the sheet using ink, there are a drying step for the sheet, and drying apparatuses which convey the sheet using the belt and, with respect to the sheet, perform drying by applying heat through the belt are developed.

In the image forming apparatuses that perform the belt conveyance as described above, even when thermal expansion of the belt occurs due to the heat applied during the sheet heating, it is desirable to control a position of the belt in an axial direction of rollers that stretch the belt. Therefore, in Japanese Patent Laid-Open No. 2020-90344, a configuration is proposed where a steering section, which applies an urging force to a belt driving device that includes a plurality of heating rollers and stretches the belt, can move in a belt thickness direction, and a displacement amount of the belt in the thickness direction is adjusted based on a detection result of the position of the belt.

In this image forming apparatus, a heater is disposed inside of a roller that stretches the belt. With this configuration, the heater heats the roller, which in turn heats the belt, thus heating the sheet being conveyed.

### SUMMARY OF THE INVENTION

According to a first aspect of the present invention, an image forming apparatus includes an image forming unit configured to form an image on a sheet, and a sheet conveyance unit configured to convey the sheet on which the image has been formed by the image forming unit. The sheet conveyance unit includes an endless belt with flexibility and configured to convey the sheet by rotation, a plurality of stretch rollers configured to stretch the belt, a tension roller configured to urge the belt, a heater disposed in at least one of the stretch rollers and the tension roller and configured to heat the belt through the roller, a first urging member, a first switching unit configured to switch the tension roller between a first state in which the tension roller does not urge the belt by not being urged with the first urging member, and a second state in which the tension roller urges the belt by a first urging force by being urged with the first urging member, a second urging member, a second switching unit configured to switch the tension roller between the second state and a third state in which the tension roller urges the belt by a second urging force that is larger than the first urging force by being urged with the second urging member, and an operation portion configured to operate the first switching unit and the second switching unit.

Further features of the present invention will become apparent from the following description of exemplary embodiments with reference to the attached drawings.

### BRIEF DESCRIPTION OF THE DRAWINGS

FIG. 1 is a cross-sectional view illustrating a schematic configuration of an inkjet recording apparatus according to a first embodiment.

FIG. 2 is a cross-sectional view illustrating a schematic configuration of a drying module according to the first embodiment.

FIG. 3 is a perspective view from a front side, illustrating a steering section of a drying belt unit according to the first embodiment.

FIG. 4 is a perspective view from a back side, illustrating the steering section of the drying belt unit according to the first embodiment.

FIG. 5 is a perspective view illustrating a tension unit in a first state of the drying belt unit according to the first embodiment.

FIG. 6 is a partially enlarged view of FIG. 5.

FIG. 7 is a perspective view illustrating the tension unit in a second state of the drying belt unit according to the first embodiment.

FIG. 8 is a partially enlarged view of FIG. 7.

FIG. 9 is a perspective view illustrating the tension unit in a third state of the drying belt unit according to the first embodiment.

FIG. 10 is a partially enlarged view of FIG. 9.

FIG. 11 is a perspective view from the front side, illustrating a state in which the tension unit is being mounted to the drying belt unit according to the first embodiment.

FIG. 12 is a perspective view from the back side, illustrating a state in which the tension unit is being mounted to the drying belt unit according to the first embodiment.

FIG. 13 is a perspective view illustrating the tension unit in the first state of a drying belt unit according to a second embodiment.

FIG. 14 is a partially enlarged view of FIG. 13.

FIG. 15 is a perspective view illustrating the tension unit in the second state of the drying belt unit according to the second embodiment.

FIG. 16 is a partially enlarged view of FIG. 15.

FIG. 17 is a perspective view illustrating the tension unit in the third state of the drying belt unit according to the second embodiment.

FIG. 18 is a partially enlarged view of FIG. 17.

### DESCRIPTION OF THE EMBODIMENTS

### First Embodiment

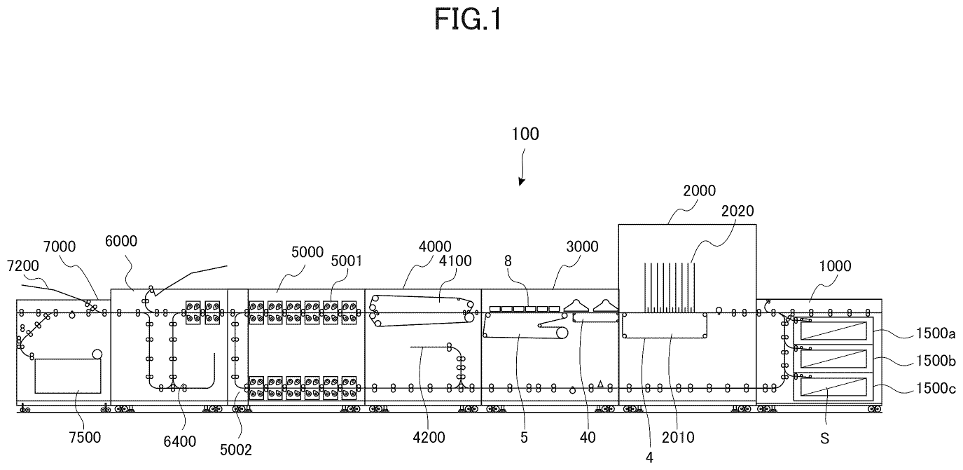

Using FIGS. 1 to 12, a first embodiment will be described. First, using FIG. 1, a schematic configuration of an inkjet recording apparatus 100 of this embodiment will be described. In this embodiment, a front side of the apparatus refers to a front side of the inkjet recording apparatus 100, and is a side on which an operational panel and the like are arranged and a user is positioned during use or operation. Then, in the illustration, the front side is marked as a forward direction F, the back side as a backward direction B, the upper side as an upward direction U, the lower side as a downward direction D, the right side from the front view as a rightward direction R, and the left side as a leftward direction L.

### Inkjet Recording Apparatus

The inkjet recording apparatus 100 of this embodiment utilizes an inkjet recording method that ejects ink to form an image on a sheet, and is a so-called sheet-fed type inkjet recording apparatus that forms the ink image on the sheet using two liquids: a reaction liquid and the ink. The inkjet recording apparatus is an example of an image forming apparatus. The sheet may be any ink-receptive recording medium, for example, paper such as standard paper and thick paper, a plastic film such as a sheet for an overhead projector, a specially shaped sheet such as an envelope and index paper, cloth, and the like.

As illustrated in FIG. 1, the inkjet recording system 100 includes a feed module 1000, a print module 2000, and a drying module 3000. Further, the inkjet recording system 100 includes a fixing module 4000, a cooling module 5000, a reverse module 6000, and a supporting module 7000. The sheet S supplied from the feed module 1000 undergoes various processes as it is conveyed along conveyance paths within each module, and is finally discharged to the supporting module 7000.

To be noted, it is acceptable that, from the feed module 1000 to the supporting module 7000, each has a separate casing, and these casings are interconnected to form the inkjet recording apparatus 100. Alternatively, the feed, print, drying, fixing, cooling, reverse, and supporting modules 1000, 2000, 3000, 4000. 5000, 6000, and 7000 may be arranged in a single casing.

The feed module 1000 includes three storage compartments 1500a, 1500b, and 1500c that store the sheet S, and each of the storage compartments 1500a to 1500c is arranged to be drawable toward the front side of the apparatus to store the sheet S. To be noted, the front side of the apparatus is the front side of the inkjet recording apparatus 100, and is the side on which the operational panel and the like are arranged and the user is positioned during use and operation. In each of the storage compartments 1500a to 1500c, the sheet S is fed one sheet at a time by a separation belt and a conveyance roller, and is conveyed to the print module 2000. To be noted, the number of the storage compartments 1500a to 1500c is not limited to three, and the feed module 1000 may include one or two, or equal to or more than four storage compartments.

The print module 2000 is an example of an image forming unit, and forms the ink image on the sheet. The print module 2000 includes a pre-imaging registration unit (not shown), a print belt unit 2010, and a recording unit 2020. An inclination and position of the sheet S conveyed from the feed module 1000 is corrected by the pre-imaging registration unit, and then the sheet S is conveyed to the print belt unit 2010. With respect to the conveyance path, the recording unit 2020 is arranged in a position that faces the print belt unit 2010. The recording unit 2020 is an inkjet recording unit that ejects the ink from above onto the sheet S being conveyed using recording heads to form the image. The plurality of recording heads that eject the ink are arranged in line along the conveyance direction. In this embodiment, there are a total of five line-type recording heads, including four colors: yellow (Y), magenta (M), cyan (C), and black (K), as well as an additional head for the reaction liquid. By conveying the sheet S via suction with the print belt unit 2010, the clearance with the recording heads is ensured.

To be noted, the variety of ink colors and the number of the recording heads are not respectively limited to four and five. To an inkjet method, methods using such as a heating element, a piezoelectric element, an electrostatic element, and a micro electromechanical system (MEMS) element can be adopted. The inks of each color are supplied from ink tanks (not shown) to each of the recording heads through ink tubes. The ink contains “0.1 mass % to 20.0 mass %” of resin components based on the total mass of the ink, along with water and water-soluble organic solvents, colorants, wax, additives, etc.

When the sheet S, on which the image has been formed by the recording unit 2020, is conveyed by the print belt unit 2010, the sheet S is detected by an inline scanner (not shown) that is arranged downstream of the recording unit 2020 in the conveyance direction of the sheet S. Here, the misalignment and color density of the image formed on the sheet S are detected, and, based on this misalignment and color density of the image, corrections to the image, density, and the like formed on the sheet S are performed.

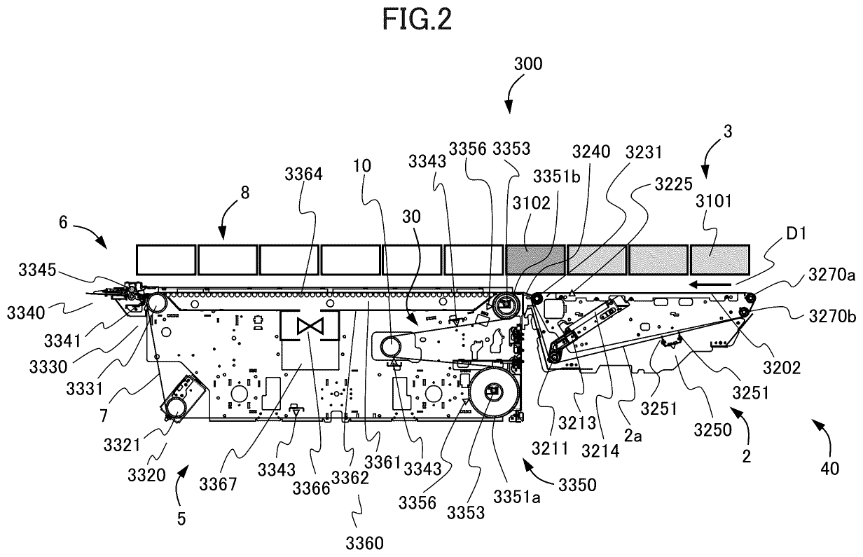

The drying module 3000 dries the sheet S by blowing air with respect to the sheet S that is conveyed to a drying belt unit 5. As illustrated in FIG. 2, the drying module 3000 includes a decoupling unit 40, the drying belt unit 5, and a warm air blowing unit 8. To improve the fixability of the ink onto the sheet S by the subsequent fixing module 4000, the drying module 3000 reduces the liquid content in the inks and reaction liquid applied to the sheet S. The sheet S on which the image has been formed is conveyed to the decoupling unit 40 arranged within the drying module 3000. In the decoupling unit 40, wind pressure applied from above generates a friction force between the sheet S and a belt, and the sheet S is conveyed by the belt. In this manner, by conveying the sheet S placed on the belt using the friction force, the misalignment of the sheet S is prevented during conveyance across the print belt unit 2010 and the decoupling unit 40. The sheet S conveyed from the decoupling unit 40 is conveyed via suction on the drying belt unit 5, and the ink and reaction liquid applied onto the sheet S are dried by being blown with hot air from the warm air blowing unit 8 arranged above the belt.

As illustrated in FIG. 1, the fixing module 4000, serving as a fixing system, includes a fixing belt unit 4100, serving as a fixing apparatus. The fixing belt unit 4100 fixes the ink on the sheet S by passing the sheet S, which has been conveyed from the drying module 3000, between an upper belt unit, which is heated, and a lower belt unit.

The cooling module 5000 includes a plurality of cooling units 5001, and cools the high-temperature sheet S conveyed from the fixing module 4000. The cooling unit 5001, for example, draws in ambient air into a cooling box with a fan to increase the internal pressure of the colling box, and cools the sheet S by directing the air from the cooling box onto the sheet S through a nozzle utilizing the pressure. With respect to the conveyance path of the sheet S, the cooling units 5001 are arranged on both sides, and cool both surfaces of the sheet S.

In the cooling module 5000, a conveyance path switching unit 5002 is disposed. The conveyance path switching unit 5002 switches the conveyance path of the sheet S depending on whether the sheet S is conveyed to the reverse module 6000 or to a duplex conveyance path for duplex printing to form the image on both sides of the sheet S.

The reverse module 6000 includes a reverse unit 6400. The reverse unit 6400 reverses the front and back of the conveyed sheet S, and changes the front-back orientation of the sheet S upon discharging into the supporting module 7000. The supporting module 7000 includes a top tray 7200 and a supporting unit 7500, and supports the sheet S conveyed from the reverse module 6000.

During the duplex printing, the sheet S is conveyed to a lower conveyance path of the cooling module 5000 by the conveyance path switching unit 5002. Thereafter, the sheet S is returned to the print module 2000 by passing through duplex conveyance paths of the fixing, drying, print, and feed modules 4000, 3000, 2000, and 1000. In a duplex conveyance unit of the fixing module 4000, a reverse unit 4200 that reverses the front and back of the sheet S is disposed. The sheet S, which has been returned to the print module 2000, receives image formation on an opposite side, which has not undergone the image formation, using the ink, and is discharged to the supporting module 7000 by passing through the drying module 3000 to the reverse module 6000.

### Drying Module

Next, using FIG. 2, the drying module 3000 will be described in detail. The drying module 3000 includes the decoupling unit 40, the drying belt unit 5, and the warm air blowing unit 8. These are collectively referred to as a drying function unit 300. The drying function unit 300 is arranged on the upper part of the drying module 3000, and includes the linear sheet conveyance path for receiving the sheet S discharged from the print module 2000 and delivering the sheet S to the fixing module 4000 after performing a drying process. With respect to the sheet conveyance direction D1 in this sheet conveyance path, there are functional differences between upstream and downstream portions of the drying function unit 300.

The decoupling unit 40 is arranged in the upstream portion of the drying function unit 300. The decoupling unit 40 includes a decoupling belt unit 2 and a cold air blowing unit 3. The cold air blowing unit 3 is arranged vertically above the decoupling belt unit 2, and the decoupling belt unit 2 conveys the sheet S substantially in the horizontal direction. The decoupling belt unit 2 includes an endless belt 2a that rotates. Then, by blowing cold air (air) using the cold air blowing unit 3 from above the decoupling belt unit 2, the sheet S is conveyance by being pressed against the belt 2a. In the decoupling belt unit 2, a plurality of perforations are provided to channel the air, which is blown by the cold air blowing unit 3, from an impingement surface to the side facing the belt. To be noted, hereinafter, the air that is not heated by a heater and the like is referred to as “cold air”.

In the decoupling belt unit 2, the belt 2a is stretched by a drive roller 3231, a tension roller 3211, and stretch rollers 3270a and 3270b. The drive roller 3231 and the stretch rollers 3270a and 3270b are rotatably supported by a frame. The tension roller 3211 is supported by slide rails 3213 in a manner that allows movement in a predetermined direction and rotation, and stretches the belt 2a by urging the belt 2a from the inside using an urging force applied by tension springs 3214. One end in a rotational axis direction of the tension roller 3211 is supported by a steering arm (not shown) thar pivots around a pivot portion as a center. In this embodiment, the rotational axis direction of the tension roller 3211 is the front-back direction of the inkjet recording apparatus 100. The steering arm is pivoted by controlling a rotation amount of a steering motor, which includes an eccentric cam, based on a detection result of an edge sensor 3225 that detects a position of an edge of the belt 2a. As a result, the steering arm adjusts a position of the belt 2a in the rotational axis direction, and performs meandering control.

When a leading edge of the sheet S has reached the decoupling belt unit 2 of the drying module 3000, a trailing edge side of the sheet S is still on the print belt unit 2010 of the print module 2000. The print belt unit 2010 includes an endless print belt 4 that conveys the sheet via suction. On the print belt 4, image formation is being performed on the sheet S, and that sheet S is conveyed via suction on the print belt 4. To prevent disturbances in this image formation process, the force which presses the sheet S against the belt 2a is weaker than a suction force of the print belt 4, and the belt 2a is driven at a slightly faster speed than the print belt 4. That is, while the trailing edge side of the sheet S remains on the print belt 4, the sheet S continuously slides with respect to the belt 2a.

On the other hand, at the moment that the trailing edge of the sheet S leaves a region of the print belt 4, the conveyance of the sheet S becomes reliant on the belt 2a. At this time, it is necessary to control an air blowing force of the cold air blowing unit 3 to prevent the sheet S from slipping due to conveyance resistance. Therefore, airflow velocity applied from the cold air blowing unit 3 to the sheet S being conveyed on the belt 2a is controlled so that a detected result of a pressure sensor (not shown) disposed inside of the cold air blowing unit 3 achieves a predetermined pressure by using an intake fan (not shown) disposed in an intake section. The cold air blowing unit 3 includes a spray surface disposed with a plurality of perforations for air passage to uniformly apply a pressing force onto the sheet S. The belt 2a is provided with numerous perforations, and is supported by a perforated metal 3202 arranged on the back of the belt 2a on a sheet conveyance surface. The perforated metal 3202 is provided with perforations that are smaller than those in the belt 2a, and allows the discharge of the airflow that is directed from the cold air blowing unit 3101 to locations other than the sheet S. In addition, to prevent the belt 2a from becoming charged and generating an excessive restraining force due to friction between the sheet S and the belt 2a, a charge on the belt 2a is neutralized using a discharging needle 3251 at a static eliminator 3250.

### Drying Unit

Next, using FIG. 2, a drying unit 6 will be described. The drying unit 6 is arranged on the downstream side of the drying function unit 300. The sheet S conveyed from the decoupling unit 40 is sent to the drying unit 6 by passing an inner sheet discharge guide 3240. The drying unit 6 includes the drying belt unit 5 and the warm air blowing unit 8. The warm air blowing unit 8 is arranged vertically above the drying belt unit 5. The drying belt unit 5 is an example of a sheet conveyance unit, and conveys the sheet S bearing the ink image substantially in the horizontal direction. In the drying unit 6, while adhering the sheet S to a drying belt 7 by suction using the drying belt unit 5, the sheet S is dried through applying the warm air from above using the warm air blowing unit 8, and is conveyed while suppressing waviness known as cockling. To be noted, while, in this embodiment, as a drying method, warm air blowing and belt heating are performed, it is not limited to this. For example, in addition to the warm air blowing, methods such as irradiating electromagnetic waves (such as ultraviolet or infrared rays) onto the surface of the sheet S, or combining it with conductive heat transfer methods through contact with heating elements may be employed.

### Drying Belt Unit

Next, using FIG. 2, the drying belt unit 5 will be described. The drying belt unit 5 includes the drying belt 7, which is an example of an endless belt having rotational flexibility. The drying belt 7 is stretched by a drive roller 3331, which is rotatably fixed, heating rollers 3351a and 3351b, a tension roller 10 supported in a manner that allows movement in a predetermined direction and rotation, and a steering roller 3321. The drying belt 7 is conveyed by the rotation of the drive roller 3331. The warm air heated by a heater, not shown, is blown from the warm air blowing unit 8, which is arranged above the drying belt unit 5, toward a side of the drying belt unit 5, and is blown onto the sheet S to which the ink has been applied. A suction unit 3360 is disposed inside of the drying belt 7. A suction chamber 3361 is formed by a suction duct 3362 and the drying belt 7, and a lower fan 3366 exhausts the air through an exhaust duct 3367 to create a negative pressure in the suction chamber 3361.

Since the drying belt 7 is perforated with numerous small holes with a diameter of approximately 0.4 millimeters (mm), a suction force is generated on the drying belt 7 over the suction unit 3360. By utilizing this suction force and the air pressure from the warm air blowing unit 8, the sheet S is conveyed by being held onto the drying belt 7. At this time, to support the drying belt 7 in a predetermined position, numerous rollers 3364 are rotatably arranged on the suction unit 3360, so that it is configured not to impede the suction by the fan 3366 while supporting the drying belt 7 from the inside.

In a course of conveying the sheet S, the ink is dried by the warm air blowing from the warm air blowing unit 8 and the heating from the drying belt 7. The heating of the drying belt 7 is performed in a belt heating unit 3350 including the first and second heating rollers 3351a and 3351b. Inside of each of the first and second heating roller 3351a and 3351b, which are examples of a stretching roller, a heater 3353 is supported. Temperatures of the first and second heating rollers 3351a and 3351b are increased through heating with the heaters 3353, and, based on detection results of roller temperature detection sensors 3356 that each detect the temperatures of the respective rollers, a temperature rise is controlled to attain a set temperature. Since heating by the heaters 3353 consumes a significant amount of power, to reduce product's power usage, it is necessary to efficiently perform the temperature rise of the drying belt 7 and the sheet S. To improve the temperature rise efficiency of the drying belt 7, it is effective to increase contact surfaces of the drying belt 7 with the first and second heating rollers 3351a and 3351b. In this embodiment, a diameter of the first heating roller 3351a is set to 110 mm, and a diameter of the second heating roller 3351b is set to 60 mm, so that the contact surfaces are expanded by increasing the diameters of the rollers.

The heat applied to the drying belt 7 dissipates by coming into contact with the atmosphere and the stretching rollers as the drying belt 7 is conveyed. Therefore, to efficiently transfer the heat from the drying belt 7 to the sheet S, it is effective to arrange the belt heating unit 3350 on the upstream side of the drying belt unit 5 in the sheet conveyance direction D1.

In this embodiment, the second heating roller 3351b is arranged on the upstream side of the drying belt unit 5 in the sheet conveyance direction D1, and the first heating roller 3351a is disposed on the further upstream side of the second heating roller 3351b. Further, between the first and second heating rollers 3351a and 3351b, the tension roller 10 urges the drying belt 7 from the outside. The tension roller 10 is an example of a tension roller, and can urge the drying belt 7. In this embodiment, to improve the heating efficiency of the drying belt 7, the contact surfaces of the first and second heating rollers 3351a and 3351b with the drying belt 7 are increased by urging the drying belt 7 with the tension roller 10 from the outside. However, it is not limited to this, and the drying belt 7 may be urged from the inside.

The temperature increase of the drying belt 7 is detected by a non-contact belt surface temperature detection sensor 3343, such as an infrared sensor, and a difference from the set temperature is determined by a control unit to adjust the temperature setting of the heater 3353. To be noted, the second heating roller 3351b is not limited to a roller that stretches a section at which the drying belt 7 faces the sheet conveyance path, and can also be another roller. Regarding the drying belt 7, a belt made of a heat resistant resin is applied. However, it is not limited to this, and high durability, large thermal capacity metal belts can also be applied.

The sheet S is heated by the heating via the drying belt 7 and the warm air from the warm air blowing unit 8, then conveyed to the internal sheet discharge unit 3340, and subsequently discharged to the fixing module 4000 by an internal sheet discharge roller 3345. The drying belt unit 5 is heated to approximately 80° C. by the warm air blowing unit 8 and the first and second heating rollers 3351a and 3351b. On the other hand, the decoupling unit 40 blows the non-heated air from the cold air blowing unit 3, and a blower unit 3102 disposed above a connecting portion with the drying belt unit 5 circulates the non-heated air by expelling and drawing the non-heated air to block the warm air blown from the warm air blowing unit 8. Therefore, with respect to sections upstream in the sheet conveyance direction D1 from the drying belt unit 5, there is no significant temperature increase, and also the influence remains restricted.

### Steering Unit

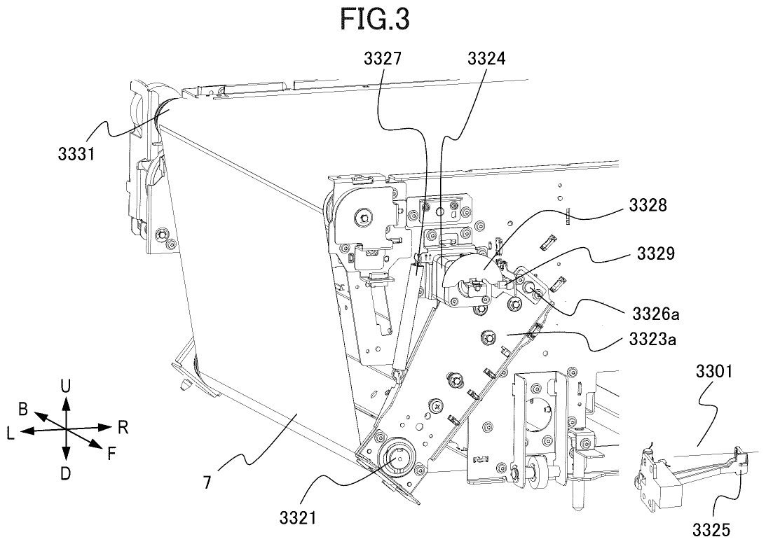

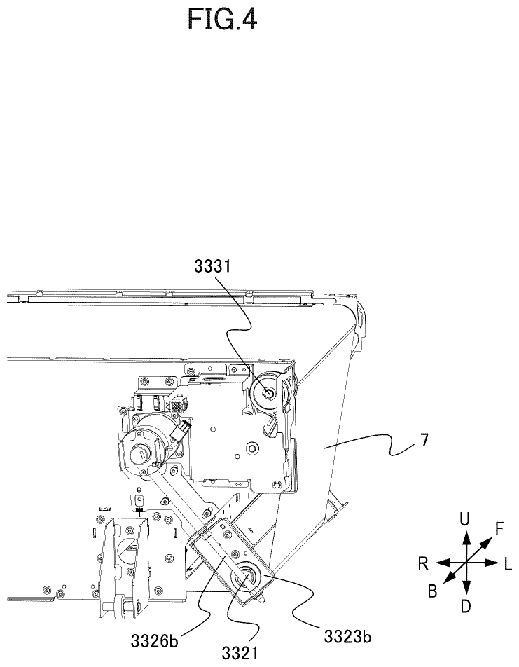

FIGS. 3 and 4 illustrate a configuration of the steering unit of the drying belt unit 5. When conveying the sheet S with the drying belt 7, it is necessary to perform belt position control to ensure that there is no significant deviation in a conveyance position in a rotational axis direction of the drying belt 7 before and after the conveyance. In this embodiment, a stretching roller arranged between the drive roller 3331 and the first heating roller 33351a is designated as the steering roller 3321. Both ends of the steering roller 3321 are rotatably supported by each of first and second steering arms 3323a and 3323b, and the first steering arm 3323a can pivot around a first pivot shaft 3326a as a center. In addition, a steering motor 3324 supports an eccentric steering cam (not shown). A steering arm spring 3327 urges the first steering arm 3323a in a direction in which part of the first steering arm 3323a is brought into contact with the steering cam. Thereby, the steering motor 3324 can pivot the first steering arm 3323a by an eccentricity amount of the steering cam.

The steering motor 3324 includes a flag 3328 on the opposite side of the axis from the steering cam. A detection position of the flag 3328 is determined through detecting the flag 3328 by the flag sensor 3329 to control the pivot amount. The other end of the steering roller 3321 is rotatably supported by the second steering arm 3323b, and the second steering arm 3323b is pivotable around a second pivot shaft 3326b as a center. The second steering arm 3323b pivots only to the extent necessary to absorb torsion that is generated when the first steering arm 3323a pivots, and does not significantly change the position of the steering roller 3321.

With this configuration, when the first steering arm 3323a of the forward direction F pivots in a predetermined direction, a thrust force along the rotational axis direction is generated on the drying belt 7 which is conveyed, and the position of the drying belt 7 is controlled. To be noted, by fixing the second steering arm 3323b without providing the second pivot shaft 3326b, it is also acceptable to configure to absorb the torsion, which occurs when the first steering arm 3323a pivots, by play in a supporting portion of the steering roller 3321.

### Tension Unit

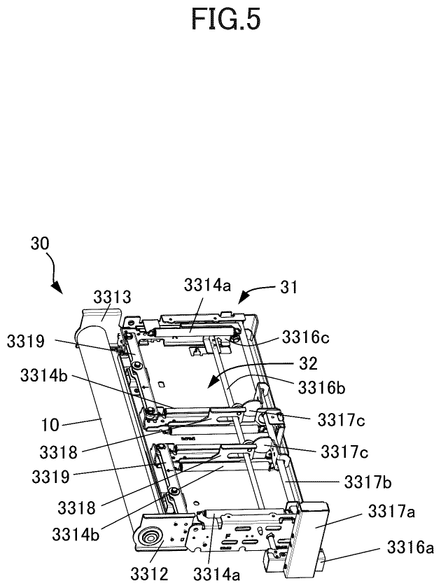

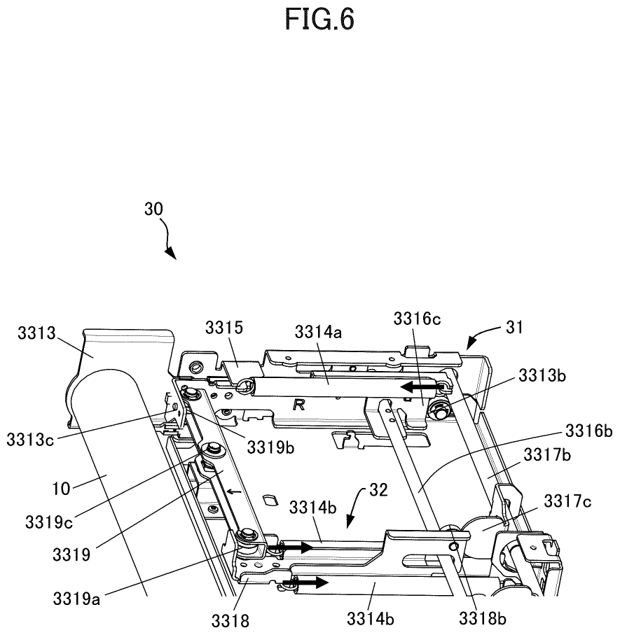

Next, using FIGS. 5 to 10, a configuration of a tension unit 30 that applies the tension to the drying belt 7 in this embodiment will be described. FIGS. 5, 7, and 9 are perspective views illustrating an internal structure of the tension unit 30. FIGS. 6, 8, and 10 are detailed views illustrating a pressing mechanism of the tension unit 30. To be noted, while FIGS. 6, 8, and 10 are diagrams illustrating the pressing configuration on one side, substantially from a center in the rotational axis direction of the tension roller 10, the configuration is also identical on the opposite side.

The tension unit 30 is a unit that can be mounted and detached with respect to the drying belt unit 5. The tension unit 30 includes first pressing units 31, which, when a first lever 3316a is operated, bring the tension roller 10 into contact with the drying belt 7 to urge the drying belt 7, and second pressing portions 32, which, when the second lever 3317a is operated, further apply the urging force to the tension roller 10. In this embodiment, two first pressing units 31 are provided, and are arranged at two different positions in the rotational axis direction of the tension roller 10 within the tension unit 30. Similarly, two second pressing units 32 are provided, and are arranged at two different positions in the rotational axis direction within the tension unit 30. In this embodiment, in the rotational axis direction, the first pressing units 31 are arranged at both end portions of the tension unit 30, and the second pressing units 32 are arranged at the center portion. Further, the first and second levers 3316a and 3317a are arranged on one side, here on the front side, of the tension unit 30 in the rotational axis direction.

The first pressing units 31 include roller support plates 3312 and 3313, first springs 3314a, first cams 3316c, and a first lever shaft 3316b. The roller support plates 3312 and 3313 are examples of a support member. The roller support plates 3312 and 3313 rotatably support the tension roller 10, and can move in a perpendicular direction (here, lateral direction) perpendicular to the rotational axis direction. The first springs 3314a are examples of a first urging member, and urge the roller support plates 3312 and 3313 in a direction, here in the leftward direction L, in which the tension roller 10 is switched from a first state to a second state by the first pressing units 31, described below. The first cams 3316c position the roller support plates 3312 and 3313 while resisting urging forces exerted by the first springs 3314a. The first lever shaft 3316b is an example of a first shaft, and is rotatably disposed by being fixed to the first cams 3316c. The first lever 3316a is an example of a first operation member and an operation portion, and, by being fixed to the first lever shaft 3316b, when the first lever shaft 3316b is rotated, can operate the tension roller 10 to switch between the first and second states by the first pressing units 31.

The second pressing units 32 include second springs 3314b, second cams 3317c, and a second lever shaft 3317b. The second springs 3314b are examples of a second urging member, and urge the roller support plates 3312 and 3313 in a direction, here in the leftward direction L, in which the tension roller 10 is switched from the second state to a third state by the second pressing units 32. The second cams 3317c position the roller support plates 3312 and 3313 while resisting the urging forces exerted by the second springs 3314b. The second lever shaft 3317b is an example of a second shaft, and is rotatably disposed by being fixed to the second cams 3317c. The second lever 3317a is an example of a second operation member and the operation portion, and, by being fixed to the second lever shaft 3317b, when the second lever shaft 3317b is rotated, can operate the tension roller 10 to switch between the second and third states by the second pressing units 32.

In addition, the second springs 3314b are arranged at different positions in the rotational axis direction from the first springs 3314a. In this embodiment, in the rotational axis direction, the first springs 3314a are arranged at both end portions of the tension unit 30, and the second springs 3314b are arranged at the center portion. Then, the second springs 3314b are connected to the roller support plates 3312 and 3313 with link members 3319.

The tension roller 10 is pivotably supported by the roller support plates 3312 and 3313, and the roller support plates 3312 and 3313 are movably supported in a predetermined direction with respect to a tension frame 3315 via slide rails (not shown). In addition, pressing plates 3318 are movably supported in a predetermined direction with respect to the tension frame 3315 via slide rails (not shown), and the link members 3319 are pivotably supported with respect to link shafts 3319c as centers. The roller support plates 3312 and 3313 are urged by the first springs 3314a, and are being pushed out toward an urging direction T1, which is a direction in which the tension roller 10 protrudes from a main body. Further, the pressing plates 3318 are urged by the second springs 3314b. The pressing plates 3318 press the link members 3319, and the link members 3319 press the roller support plates 3312 and 3313. Thereby, the urging force which pushes the tension roller 10 in the urging direction T1 is added.

In this embodiment, the drying belt 7 uses a material made of a high heat resistant resin. To ensure the drying belt 7 is stretched without sagging in a stretched state, similar to a pulley system, it is necessary to apply a large force. For example, in this embodiment, when the tension unit 30 is mounted into the drying belt unit 5 and urges the drying belt 7, a large tension such as 370 newtons (N) is applied to the drying belt 7, and an operator is required to exert a substantial force to apply and release the urging force. Therefore, in this embodiment, to reduce the operator load, the application and release of the urging force are switched in two stages with the first and second levers 3316a and 3317a. The first and second levers 3316a and 3317a are respectively connected to the first and second lever shafts 3316b and 3317b, and are rotatably supported by the tension frame 3315.

### Procedure to Apply and Release Urging Force

Next, a procedure to apply and release the urging force will be described. In this embodiment, with respect to the tension status of the drying belt 7, it is designed to switch among three states: the first to third states. Hereinafter, each state will be described in detail.

### First State

FIGS. 5 and 6 illustrates the first state in which the first and the second levers 3316a and 3317a are in a pressure release state and the tension is not applied to the drying belt 7. The roller support plates 3312 and 3313 are respectively provided with contact portions 3312b and 3313b. The first cams 3316c, which are eccentric cams and are connected to the first lever shaft 3316b, come into contact with the contact portions 3312b and 3313b, and urge the roller support plates 3312 and 3313 oppositely to a direction urged by the first springs 3314a.

Thereby, the tension roller 10 is positioned to be separated from the drying belt 7. At the same time, the second cams 3317c, which are eccentric cams and are connected to the second lever shaft 3317b, come into contact with contact portions 3318b disposed on the pressing plates 3318, and urge the pressing plates 3318 oppositely to a direction urged by the second springs 3314b. Thereby, the pressing plates 3318 are in positions where the forces exerted to press the roller support plates 3312 and 3313 via the link members 3319 are released.

### Second State

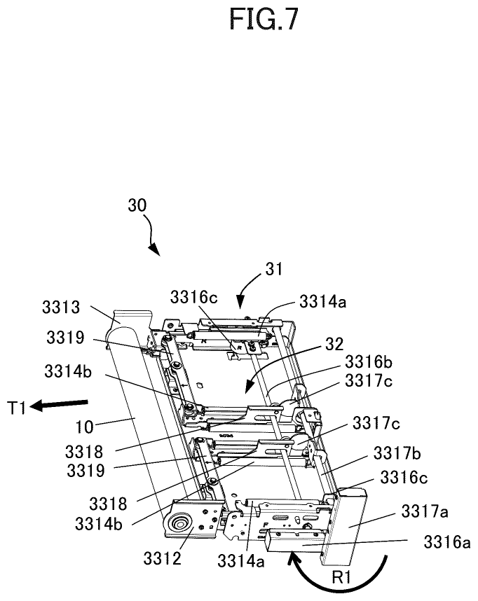

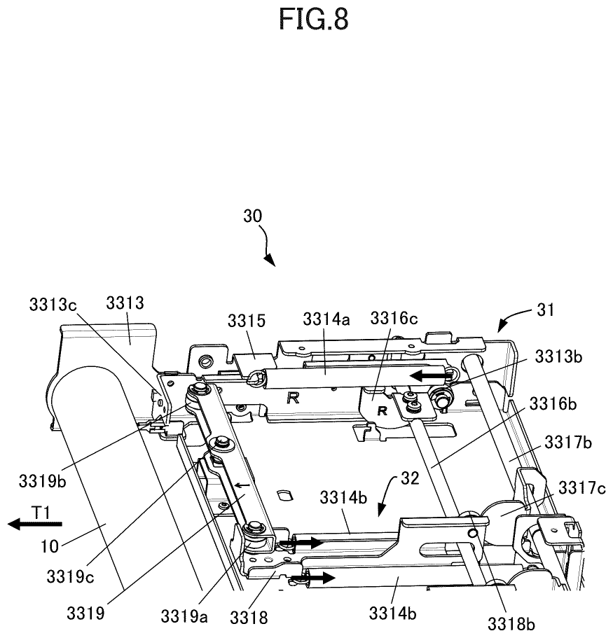

Next, when the first lever 3316a is rotated from the first state illustrated in FIGS. 5 and 6 in an arrow R1 direction in FIG. 7, the tension roller 10 becomes the second state illustrated in FIGS. 7 and 8. At this time, the first cams 3316c are separated from the respective contact portions 3312b and 3313b of the roller support plates 3312 and 3313. Then, the roller support plates 3312 and 3313 are urged by the first springs 3314a, and the tension roller 10 comes into contact with the drying belt 7. By the urging forces of the first springs 3314, a posture of the drying belt 7 is maintained from the first state in which the drying belt 7 is unloaded and slackened.

On the other hand, when the first lever 3316a is rotated in a direction opposite to the arrow R1 direction in FIG. 7, the first cams 3316c again come into contact with the contact portions 3312b and 3313b, and the roller support plates 3312 and 3313 move in a direction to separate the tension roller 10 from the drying belt 7. Thereby, the tension roller 10 returns to the first state. In this embodiment, in this second state, a force (first urging force) that the tension roller 10 exerts to press the drying belt 7 is set to 80 N.

### Third State

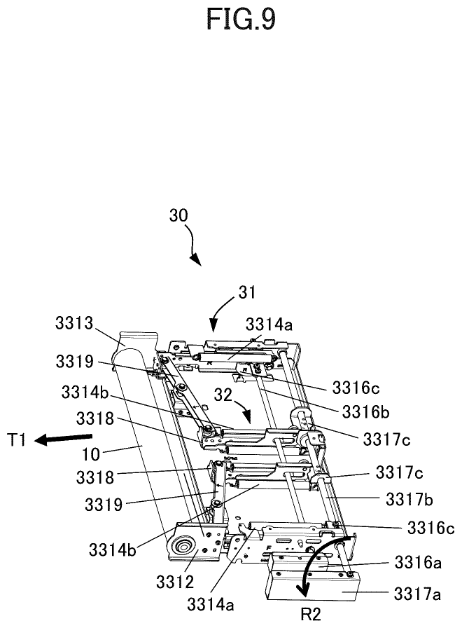

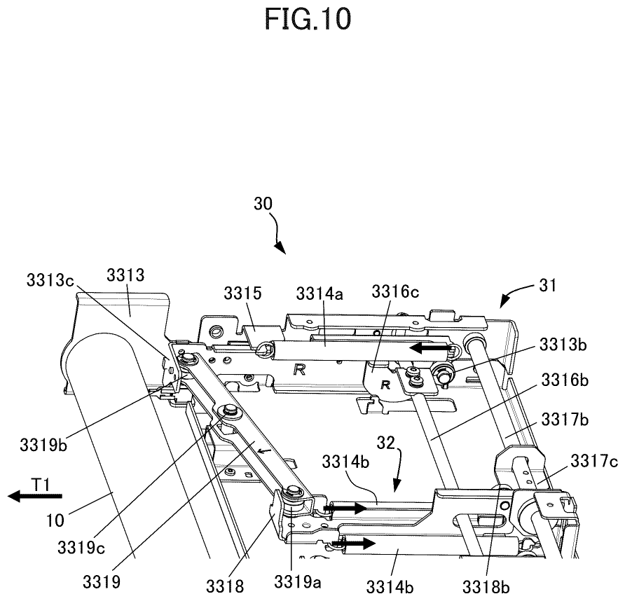

Next, when the second lever 3316a is rotated in an arrow R2 direction in FIG. 9 from the second state illustrated in FIGS. 7 and 8, the tension roller 10 becomes the third state illustrated in FIGS. 9 and 10. At this time, the second cams 3317c are separated from the contact portions 3318b of the pressing plates 3318. Then, the pressing plates 3318 are urged by the second springs 3314b, and the pressing plates 3318 press first end portions 3319a of the link members 3319. The link members 3319 pivot around the link shafts 3319c as centers, and second end portions 3319b come into contact with and press against respective abutment portions 3312c and 3313c of the roller support plates 3312 and 3313. Thereby, in addition to the urging forces exerted by the first springs 3314a, urging forces are applied to the roller support plates 3312 and 3313 by the second springs 3314b via the link members 3319. By receiving the desired urging force from the tension roller 10, the drying belt 7 becomes the third state that is a tensioned state, and becomes an operational state for the image formation.

On the other hand, when the second lever 3317a is rotated in a direction opposite to the arrow R2 direction in FIG. 9, the second cams 3317c again come into contact with the contact portions 3318b, and the pressing plates 3318 are moved to positions where the urging forces exerted by the second springs 3314b are released. Thereby, the transfer of the forces to the roller support plates 3312 and 3313 via the link members 3319 is released, and the tension roller 10 returns to the second state. In this embodiment, in this third state, the force (second urging force) exerted by the tension roller 10 to press the drying belt 7 is set to 370 N. That is, with respect to the urging force of 370N, at which the drying belt 7 is tensioned and is brought into the operational state (third state), the urging force of 80 N (approximately 22%) was applied beforehand in the second state.

As described above, the first pressing units 31 can switch the tension roller 10 between the first state in which the tension roller 10 does not urge the drying belt 7, and the second state in which the tension roller 10 urges the drying belt 7 with the first urging force (80 N). In addition, the second pressing units 32 can switch the tension roller 10 between the second state which is switched by the first pressing units 31, and the third state in which the tension roller 10 urges the drying belt 7 with the second urging force (370 N) that is larger than the first urging force (80 N).

As described above, the urging force is distributed in two stages by the first and second lever 3316a and 3317a, and the operation force exerted to apply and release the urging force is reduced. In addition, after applying the urging force to hold the tensioning posture of the drying belt 7 in the first stage, 370 N is applied in the second stage. Thereby, rather than suddenly applying the substantial urging force of 370 N to the drying belt 7 from the state in which the drying belt is slackened due to the unloaded state (first state), the impact of the load on the drying belt 7 is mitigated, and it is possible to improve durability.

To be noted, in this embodiment, as illustrated in FIG. 9, when in the third state, the second lever 3317a is arranged to overlap on the front side of the first lever 3316a. Thereby, the operator who attempts to switch the tension roller 10 from the third state to the first state is directed to operate from the second lever 3317a, and is guided into the correct operational sequence.

### Mounting and Detachment of Tension Unit

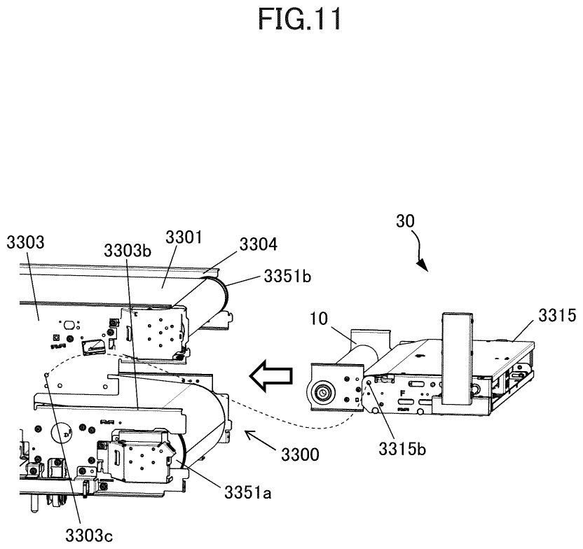

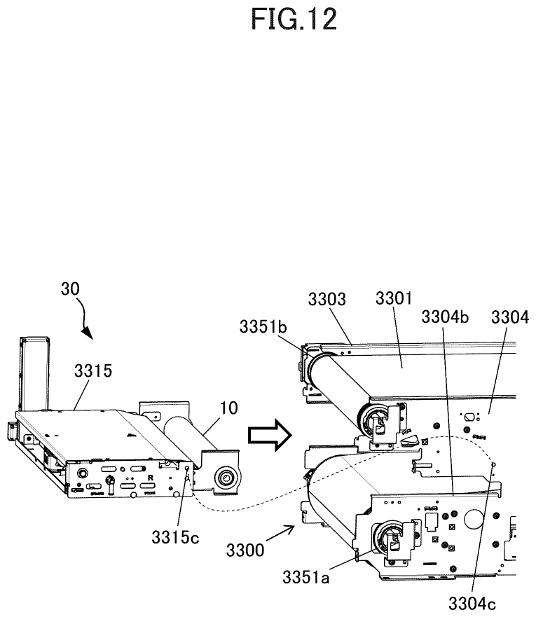

Using FIGS. 11 and 12, a procedure to mount and detach the tension unit 30 will be described. FIGS. 11 and 12 illustrate a state in which the tension unit 30 is being mounted into the drying belt unit 5. The tension unit 30, which is in the first state in which the tension roller 10 is receded by the operation of the first and second levers 3316a and 3317a, is mounted from the right side of the drying belt unit 5.

Regarding the tension unit 30, the tension frame 3315 is guided by guide portions 3303b and 3304b respectively disposed to a front-side plate 3303 and a back-side plate 3304. Thereby, a surface of the tension roller 10 engages with the drying belt 7, and a risk of inadvertent impact on other regions, which might damage a surface of the drying belt 7, is mitigated. Then, by engaging respective positioning portions 3303c and 3304c of the front-side and back-side plates 3303 and 3304 with positioning portions 3315b and 3315c of the tension frame 3315, the tension unit 30 is positioned with respect to the drying belt unit 5.

As described above, according to the tension unit 30 of this embodiment, the first pressing units 31 capable of switching the tension roller 10 between the first and second states and the second pressing units 32 capable of switching the tension roller 10 between the second and third states are included. Therefore, since, when switching the tension roller 10 from the first state to the third state, the operation can be executed by dividing it into two stages, it is possible to reduce the operation force required per action compared to the operation executed in a single stage. Thereby, it is possible to improve operability when applying and releasing the tension to and from the drying belt 7.

Further, according to the tension unit 30 of this embodiment, in addition to the effect described above, it is possible to distribute the urging force so as not to suddenly apply the substantial urging force from the state in which the drying belt 7 is in the unloaded state. Thereby, rather than suddenly applying the substantial urging force of 370 N to the drying belt 7 from the state in which the drying belt is slackened due to the unloaded first state, the impact of the load on the drying belt 7 is mitigated, and it is possible to improve the durability.

### Second Embodiment

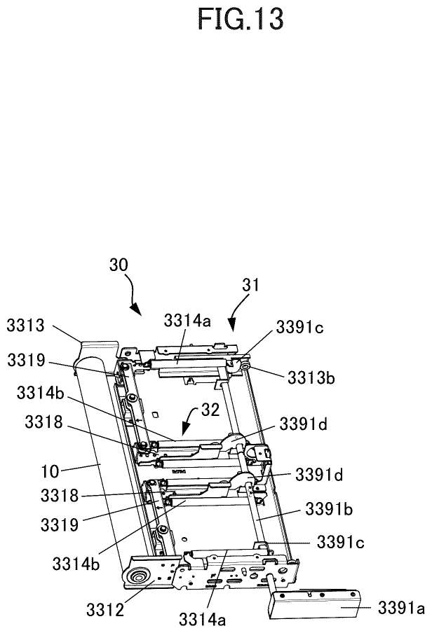

Next, with reference to FIGS. 13 to 18, a second embodiment of this disclosure will be described in detail. In this embodiment, the first and second cams 3391c and 3391d are configured coaxially and operated by a single operation lever 3391a, which differentiates the configuration from the first embodiment. However, since other configurations are the same as the first embodiment, the detailed description will be omitted by employing the same reference characters.

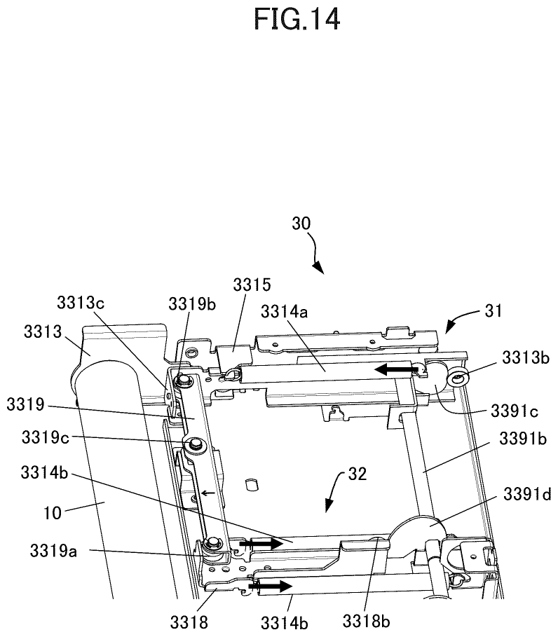

Using FIGS. 13 to 18, a configuration of a tension unit 30 of this embodiment will be described. FIGS. 13, 15, and 17 are perspective views illustrating an internal structure of the tension unit 30. FIGS. 14, 16, and 18 are detailed views illustrating a pressing mechanism of the tension unit 30. To be noted, while FIGS. 14, 16, and 18 are diagrams illustrating the pressing configuration on one side, substantially from the center in the rotational axis direction of the tension roller 10, the opposite side has also an identical configuration.

As with the first embodiment, in the tension unit 30, the roller support plates 3312 and 3313 that rotatably support the tension roller 10 via the slide rails (not shown) are supported by the tension frame 3315. In addition, the pressing plates 3318, the link members 3319 are supported by the tension frame 3315. Further, the support plates 3312 and 3313 are urged by the first springs 3314a, and the pressing plates 3318 are urged by the second springs 3314b.

In addition, the first pressing units 31 include the first cams 3391c, which position the roller support plates 3312 and 3313 while resisting the urging forces by the first springs 3314a, and a rotation shaft 3391b which is rotatably fixed to the first cams 3391c. The second pressing units 32 include the second cams 3391d that position the roller support plates 3312 and 3313 while resisting the urging forces of the second springs 3314b, and are rotatably fixed to the rotation shaft 3391b.

Then, the operation lever 3391a is connected to the rotation shaft 3391b, and is pivotably supported by the tension frame 3315. In addition, the first and second cams 3391c and 3391d, which possess an eccentric shape, are connected to the rotation shaft 3391b. As illustrated in FIGS. 13 and 14, the first cams 3391c come into contact with the respective contact portions 3312b and 3313b of the roller support plates 3312 and 3313, and urge the roller support plates 3312 and 3313 in a direction opposite to the urging direction by the first springs 3314a.

At the same time, the second cams 3391d come into contact with the contact portions 3318b of the pressing plates 3318, and urge the pressing plates 3318 in a direction opposite to the urging direction by the second springs 3314b. Thereby, the tension roller 10 becomes the first state in which the tension roller 10 is separated from the drying belt 7.

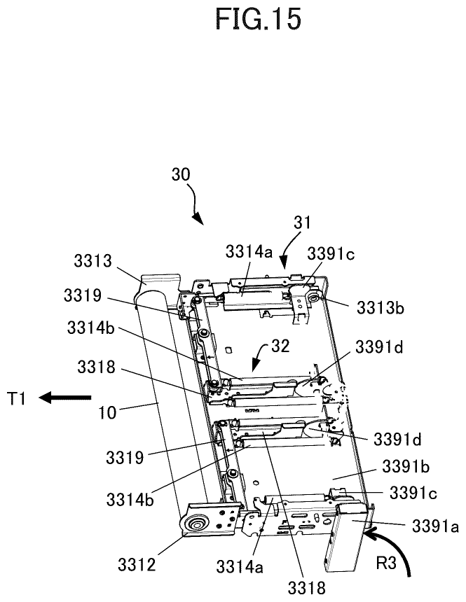

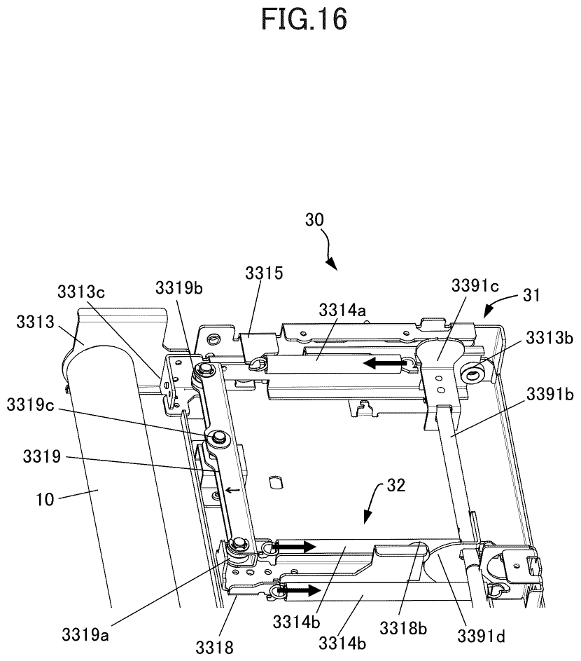

Next, when the operation lever 3391a is rotated by 90 degrees in an arrow R3 direction illustrated in FIG. 15, as illustrated in FIGS. 15 and 16, the first cams 3391c are separated from the respective contact portions 3312b and 3313b of the roller support plates 3312 and 3313, and the roller support plates move in the urging direction Tl by the urging forces of the first springs 3314a. Thereby, the tension roller 10 comes into contact with the drying belt 7, and the tension roller 10 becomes the second state in which the posture of the drying belt 7 is maintained.

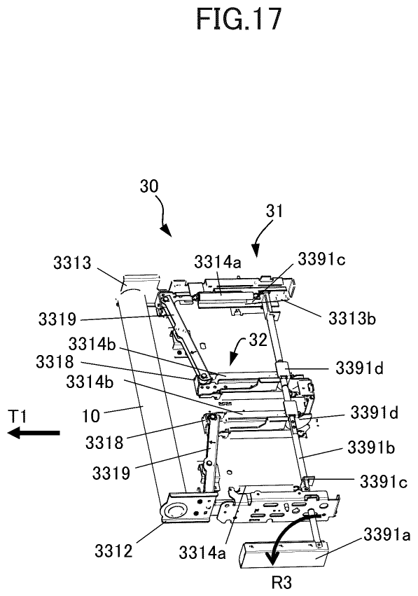

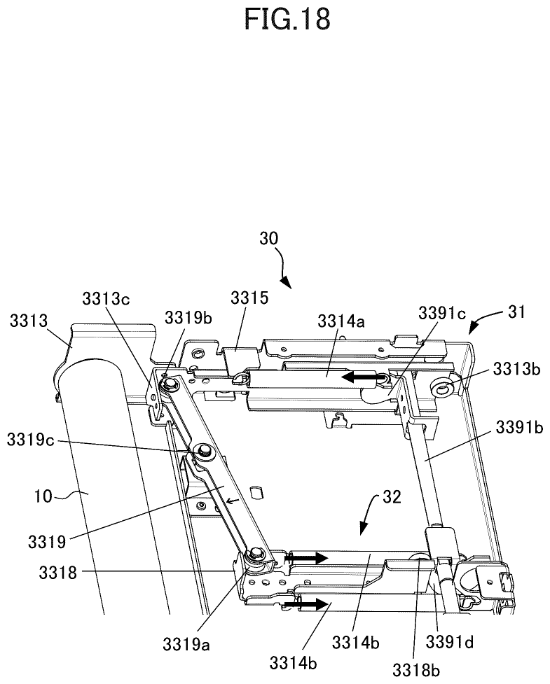

Next, when the operation lever 3391a is further rotated by 90 degrees in the arrow R3 direction illustrated in FIG. 17, as illustrated in FIGS. 17 and 18, the second cams 3391d are separated from the contact portions 3318b of the pressing plates 3318, and the pressing plates 3318 press the first end portions 3319a of the link members 3319 by being urged by the second springs 3314b. The link members 3319 pivot around the pivot shafts 3319c as centers, and the second end portions 3319b engage and press the respective abutment portions 3312c and 3313c of the roller support plates 3312 and 3313. Thereby, in addition to the urging forces of the first springs 3314a, the urging forces by the second springs 3314b are applied to the roller support plates 3312 and 3313, and the drying belt 7 becomes the third state in which the drying belt 7 is tensioned by receiving the desired urging force from the tension roller 10. As described above, the urging force that the tension roller 10 applies to the drying belt 7 varies depending on an operational phase of the operation lever 3391a, and it is possible to reduce the operation force.

As described above, also in this embodiment, the operation lever 3391a is fixed to the rotation shaft 3391b, and, by rotating the rotation shaft 3391b, it is possible to switch the tension roller 10 between the first and second states and between the second and third states. Therefore, it is possible to perform the operation to apply and release the urging force in two stages by the phase of the single operation lever 3391a. Thereby. it is possible to obtain the same effect as the first embodiment, that is, in addition to reducing the operation force required to apply and release the urging force applied to the drying belt 7, it is possible to distribute the urging force so as not to suddenly apply the substantial urging force from the state in which the drying belt 7 is in the unloaded state.

### OTHER EMBODIMENTS

To be noted, while in the embodiments described above, the belt heating unit 3350 includes two rollers, namely the first and second heating rollers 3351a and 3351b, it is not limited to this. For example, a heater can be disposed inside of the tension roller 10. That is, it is acceptable if the heater is disposed in at least one of the first heating roller 3351a, the second heating roller 3351b, and the tension roller 10. Alternatively, the heater may be disposed on an outer circumference of a roller to heat the roller.

In addition, while, in the embodiments described above, by displacing the steering motor 3321 with the first steering arm 3323a, which pivots around the pivot center, the belt meandering control is performed, it is not limited to this configuration. This configuration can also be applied to configurations, for example, where the position of the steering motor 3321 cannot respond to changes in a circumference of the drying belt 7, or the meandering control characteristics deteriorate. For example, this configuration can be applied to an automatic alignment mechanism that regulates the meandering of the drying belt 7 by providing guide ribs at the edges of the drying belt 7, or a meandering control mechanism that generates a tension differential at the belt edges.

In addition, while, in the embodiments described above, the operation member used for applying and releasing the tension is a lever, it is not limited to this, and a tension-inducing configuration using wire tensioning may also be applied.

In addition, while, in the embodiments described above, this disclosure is applied to the inkjet recording apparatus 100, serving as the image forming apparatus, it is not limited to this. For example, this disclosure can also be applied to image forming apparatuses of an electrophotographic system using toner, and similar effects to the embodiments described above can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-051921, filed Mar. 27, 2024, which is hereby incorporated by reference herein in its entirety.

What is claimed is:

1. An image forming apparatus comprising:
an image forming unit configured to form an image on a sheet; and
a sheet conveyance unit configured to convey the sheet on which the image has been formed by the image forming unit,
wherein the sheet conveyance unit includes:
an endless belt with flexibility and configured to convey the sheet by rotation;
a plurality of stretch rollers configured to stretch the belt;
a tension roller configured to urge the belt;
a heater disposed in at least one of the stretch rollers and the tension roller and configured to heat the belt through the roller;
a first urging member;
a first switching unit configured to switch the tension roller between a first state in which the tension roller does not urge the belt by not being urged with the first urging member, and a second state in which the tension roller urges the belt by a first urging force by being urged with the first urging member;
a second urging member;
a second switching unit configured to switch the tension roller between the second state and a third state in which the tension roller urges the belt by a second urging force that is larger than the first urging force by being urged with the second urging member; and
an operation portion configured to operate the first switching unit and the second switching unit.

2. The image forming apparatus according to claim 1,
wherein the first urging member is one of first urging members arranged at two different positions of the sheet conveyance unit in a rotational axis direction of the tension roller, and
wherein the second urging member is one of second urging members arranged at two different positions of the sheet conveyance unit in the rotational axis direction.

3. The image forming apparatus according to claim 1, wherein the operation portion is arranged on one side of the sheet conveyance unit in a rotational axis direction of the tension roller.

4. The image forming apparatus according to claim 1,
wherein the first switching unit includes:
a support member configured to rotatably support the tension roller and move in a perpendicular direction perpendicular to a rotational axis direction of the tension roller;
a first cam configured to position the support member while resisting an urging force urged by the first urging member; and
a first shaft fixed to the first cam and configured to rotate,
wherein, in a state where the support member is urged by the first urging member, the tension roller urges the belt by the first urging force, and
wherein, in a state where the first shaft is rotated, the first switching unit switches the tension roller between the first state and the second state.

5. The image forming apparatus according to claim 4,
wherein the second switching unit includes:
a second cam configured to position the support member while resisting an urging force urged by the second urging member; and
a second shaft fixed to the second cam and configured to rotate,
wherein, in a state where the support member is urged by the second urging member, the tension roller urges the belt by the second urging force, and
wherein, in a state where the second shaft is rotated, the second switching unit switches the tension roller between the second state and the third state.

6. The image forming apparatus according to claim 1, wherein the operation portion includes an operation member configured to operate the first switching unit and the second switching unit.

7. The image forming apparatus according to claim 1, wherein the operation portion includes a first operation member configured to operate the first switching unit, and a second operation member configured to operate the second switching unit.

8. The image forming apparatus according to claim 1, wherein the image forming unit includes an inkjet recording unit configured to form the image on the sheet by using ink.
